(19) United States
(12) Patent Application Publication
(10) Pub. No.: US 2013/0301625 A1
(43) Pub. Date: Nov. 14, 2013

(54) AGGREGATION OF INFORMATION UNITS IN A WIRELESS NETWORK

(71) Applicants: Alexander Thoukydides, Cambridge (GB); Fei Tong, Royston (GB); Wei Shi, Cambridge (GB)

(72) Inventors: Alexander Thoukydides, Cambridge (GB); Fei Tong, Royston (GB); Wei Shi, Cambridge (GB)

(73) Assignee: Cambridge Silicon Radio Limited, Cambridge (GB)

(21) Appl. No.: 13/470,035

(22) Filed: May 11, 2012

(51) Int. Cl. H04W 84/12; H04W 84/02

(52) U.S. Cl. 370/338; 370/328

(57) ABSTRACT

The present application relates to a method for transmitting information from a wireless access point to one or more wireless stations. The method comprises aggregating a plurality of information units of compatible types, such as MAC protocol data units (MPDUs) or acknowledgements into a single data frame, modulating the single data frame and transmitting the modulated data frame containing the plurality of information units to the one or more wireless stations.

### TECHNICAL FIELD

The present application relates to a method for transmitting information from a wireless access point to one or more wireless stations, and to wireless access point.

### BACKGROUND TO THE INVENTION

Certain amendments to the IEEE 802.11 standard for wireless local networking (sometimes referred to as Wi-Fi) define an orthogonal frequency division multiplexing (OFDM) physical layer operating in the license-exempt frequency bands below 1 GHz. The aim of the 802.11ah amendment is to support new outdoor use cases for wireless local networking systems, such as smart grids (i.e. electrical grids that collect and distribute data about producers and consumers of electricity using the grid to improve efficiency, reliability and other properties of the electrical grid), industrial process sensor networks and extended range wireless local networks for carrying traffic from cellular telephone networks.

For smart grids and industrial process sensor networks the required data rate is typically low, at around 100 kbps. Data traffic patterns are periodic, and payload sizes are small, e.g. around 250 bits per packet. However, each data frame contains a fixed length header and inter-frame spacing, and so the small size of the data payload (or protocol data unit, PDU) leads to inefficient use of the available frequency spectrum, since the header and inter-frame spacing occupy a disproportionately large number of bits, as compared to the PDU.

These applications also involve very large numbers of devices operating on the same channel, so even with a relatively low packet rate there will be contention for access to the wireless medium. Collisions will occur when multiple wireless stations choose the same time to initiate their transmissions, resulting in exponentially increasing back-off for retransmission attempts and a reduction in modulation rate to compensate for perceived poor channel conditions.

The IEEE 802.11 standard incorporates aggregation mechanisms (referred to as A-MPDU and A-MSDU) for aggregating multiple frames to reduce the overheads associated with transmitting multiple small frames. However, these aggregation mechanisms are restricted, in that they support frames that are all intended to be received by the same wireless station (and that are in the same access category for quality of service), so they only offer significant benefit when high throughput traffic streams are being supported between a small number of wireless stations.

A similar problem of inefficient use of the available frequency spectrum can occur in the transmission of acknowledge (ACK) frames from a wireless access point to wireless stations. Block ACK frames can be used to improve efficiency when multiple frames are transmitted between an access point and a single station, by permitting multiple received PDUs to be acknowledged with a single block ACK frame, rather than requiring multiple individual ACK frames. However, when the transmission duty cycle is low, the use of block ACK frames introduces high retransmission delays, and any improvement in spectral efficiency across the whole of the network is marginal.

### SUMMARY OF INVENTION

According to a first aspect of the invention there is provided a method for transmitting information from a wireless access point to one or more wireless stations, the method comprising aggregating a plurality of information units of compatible types into a single data frame, modulating the single data frame and transmitting the modulated data frame containing the plurality of information units to the one or more wireless stations.

By aggregating information units of compatible types into a single data frame, modulating the single data frame and transmitting the modulated single data frame in this way, the transmission overhead of the plurality of information units is reduced, as only a single header associated with the plurality of information units need be transmitted. This improves the efficiency with which the available frequency spectrum is used.

The method may use a carrier sense multiple access with collision avoidance (CSMA/CA) medium access protocol

The plurality of information units may comprise a plurality of IEEE 802.11 MAC protocol data units (MPDUs).

In this case, the single frame may include an indicator for indicating whether a data portion of the frame contains a plurality of MPDUs intended for different wireless stations.

The indicator may be provided in a signalling field of the single frame.

The plurality of MPDUs may be provided in a data portion of the single frame, and each of the plurality of MPDUs may be associated with a header containing information specifying the length of its associated MPDU.

The single data frame may further include a map field, the map field indicating wireless stations for which the MPDUs of the single data frame may be intended. This enables wireless stations for which the MPDUs of the single data frame are not intended to reduce their power consumption by turning their receiver off for the rest of the frame.

The map field may comprise a bitmap containing a plurality of bits, each bit of the bitmap indicating the inclusion of one or more MPDUs for members of a group of wireless stations.

Alternatively, the plurality of information units may comprise a plurality of acknowledgements for MPDUs received from one or more wireless stations.

In this case, the single frame may further include a single frame control field, a duration field, a single transmitter address field and a single frame check sequence field.

The frame control field may contain an indicator to indicate whether the single frame contains a plurality of acknowledgements for one or more wireless stations.

The wireless access point may be configured to inform the one or more wireless stations of an acknowledge timeout period to determine how long the one or more wireless stations should wait to receive an acknowledgement from the wireless access point.

According to a second aspect of the invention, there is provided a wireless access point comprising an aggregator configured to aggregate a plurality of information units of compatible types into a single data frame, a modulator configured to modulate the single data frame for transmission to one or more wireless stations.

The wireless access point may be configured to use a carrier sense multiple access with collision avoidance (CSMA/CA) medium access protocol

The plurality of information units may comprise a plurality of IEEE 802.11 MAC protocol data units (MPDUs).

In this case, the single frame may include an indicator for indicating whether a data portion of the frame contains a plurality of MPDUs intended for different wireless stations.

The indicator may be provided in a signalling field of the single frame.

The plurality of MPDUs may be provided in a data portion of the single frame, and each of the plurality of MPDUs may be associated with a header containing information specifying the length of its associated MPDU.

The single data frame may further include a map field, the map field indicating wireless stations for which the MPDUs of the single data frame may be intended.

The map field may comprise a bitmap containing a plurality of bits, each bit of the bitmap indicating the inclusion of one or more MPDUs for members of a group of wireless stations.

Alternatively, the plurality of information units may comprise a plurality of acknowledgements for MPDUs received from one or more wireless stations.

In this case, the single frame may further include a single frame control field, a duration field, a single transmitter address field and a single frame check sequence field.

The frame control field may contain an indicator to indicate whether the single frame contains a plurality of acknowledgements.

The wireless access point may be configured to inform the one or more wireless stations of an acknowledge timeout period to determine how long the one or more wireless stations should wait to receive an acknowledgement from the wireless access point.

According to a further aspect of the invention there is provided a transmission format for transmission of information from a wireless access point to one or more wireless stations, the transmission format comprising a plurality of information units of compatible types aggregated within a single data frame.

The plurality of information units may comprise a plurality of IEEE 802.11 MAC protocol data units (MPDUs).

Alternatively the plurality of information units may comprise a plurality of acknowledgements for MPDUs received from one or more wireless stations.

According to a further aspect of the invention there is provided a method of receiving at a wireless station a data frame transmitted by a wireless access point, the data frame containing a plurality of IEEE 802.11 MAC protocol data units (MPDUs), the method comprising identifying an nth one of the plurality of MPDUs that is intended for the receiving wireless station and transmitting an acknowledgement (ACK) to the wireless access point in a time slot commencing (n×SIFS)+((n−1)×T_ACK) after the end of the data frame received by the wireless station, where SIFS is the duration of a short inter-frame space and T_ACK is the duration of an ACK transmitted by the wireless station to the wireless access point.

According to a further aspect of the invention there is provided a wireless station for receiving from a wireless access point a data frame containing a plurality of IEEE 802.11 MAC protocol data units (MPDUs), the wireless station being configured to identify an nth one of the plurality of MPDUs that is intended for the wireless station and to transmit an acknowledgement (ACK) to the wireless access point in a time slot commencing (n×SIFS)+((n−1)×T_ACK) after the end of the data frame received by the wireless station, where SIFS is the duration of a short inter-frame space and T_ACK is the duration of an ACK transmitted by the wireless station to the wireless access point.

### BRIEF DESCRIPTION OF THE DRAWINGS

Embodiments of the invention will now be described, strictly by way of example only, with reference to the accompanying drawings, of which

FIG. 1 is a schematic representation of part of a transmitter;

FIG. 2 is a schematic representation of a physical layer frame containing a plurality of MAC Protocol Data Units (MPDUs) intended for different wireless stations.

FIGS. 3 to 5 are schematic representations illustrating acknowledgement of MPDUs transmitted by an access point;

FIG. 6 is a schematic representation illustrating a multi-user aggregation acknowledge frame (MUA-ACK); and

FIG. 7 is a schematic representation illustrating timeouts for stations receiving MUA-ACK frames from an access point.

### DESCRIPTION OF THE EMBODIMENTS

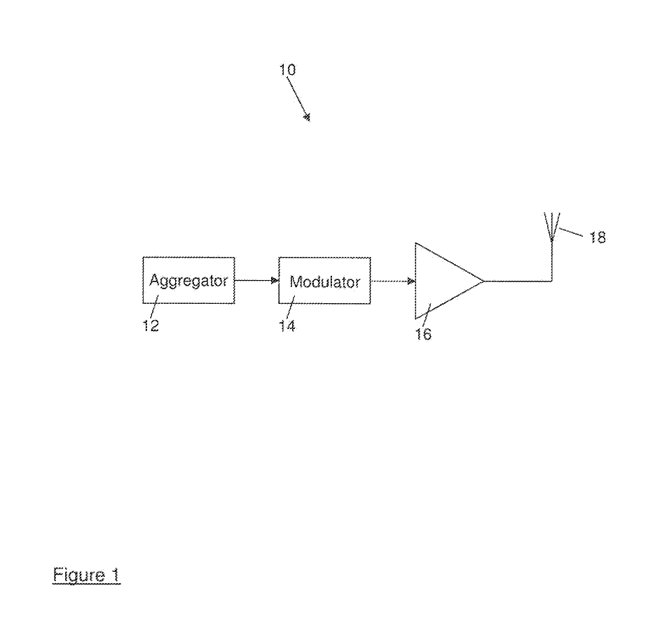

FIG. 1 is a schematic representation showing functional blocks that are present in a transmitter implementing the method of the present invention. It is to be appreciated that the functional blocks shown in FIG. 1 are not necessarily representative of physical components of a transmitter, but are presented to aid understanding of the invention. Moreover, it is to be appreciated that only those functional blocks that are relevant to the invention are shown in FIG. 1, and that a “real world” implementation of a transmitter will include further functional blocks and components in addition to those illustrated in FIG. 1.

The transmitter of FIG. 1 may be or may form part of a wireless access point (AP) 10 operating in accordance with the IEEE 802.11 standard to transmit signals using a carrier sense multiple access with collision avoidance (CSMA/CA) medium access protocol. The transmitter includes an aggregator 12 that is configured to aggregate information units of compatible types that are intended for transmission to one or more wireless stations.

The information units may be, for example, MAC protocol data units (MPDUs) of type Data or type Management intended for one or more wireless stations (STAs) in the wireless network served by the AP (e.g. for broadcast or multicast transmissions) into a single frame. Where the single frame contains aggregated MPDUs, it will be referred to hereinafter as a multi-user aggregation MPDU, or MUA-MPDU.

Alternatively, the information units may be acknowledgements intended for one or more wireless stations in the wireless network served by the AP. Where the single frame contains aggregated acknowledgements, it will be referred to hereinafter as a multi-user aggregation ACK MPU, or MUA-ACK MPDU.

The transmitter also includes a modulator 14 that operates in the physical layer to apply a single modulation and coding scheme to the MUA-MPDU for downlink transmission to one or more receiving wireless stations. The modulated and coded frame (e.g. MUA-MPDU or MUA-ACK MPDU) forms part of a signal that is amplified by one or more amplifiers 16 and transmitted via one or more antennas 18 to the wireless station(s) of the wireless network served by the wireless access point 10.

By aggregating information units such as MPDUs or acknowledgements into a single frame in this way the available frequency spectrum is used more efficiently, as any preamble, header or the like associated with the information unit are transmitted only once, in the single frame, rather than being transmitted separately in multiple frames for each information unit.

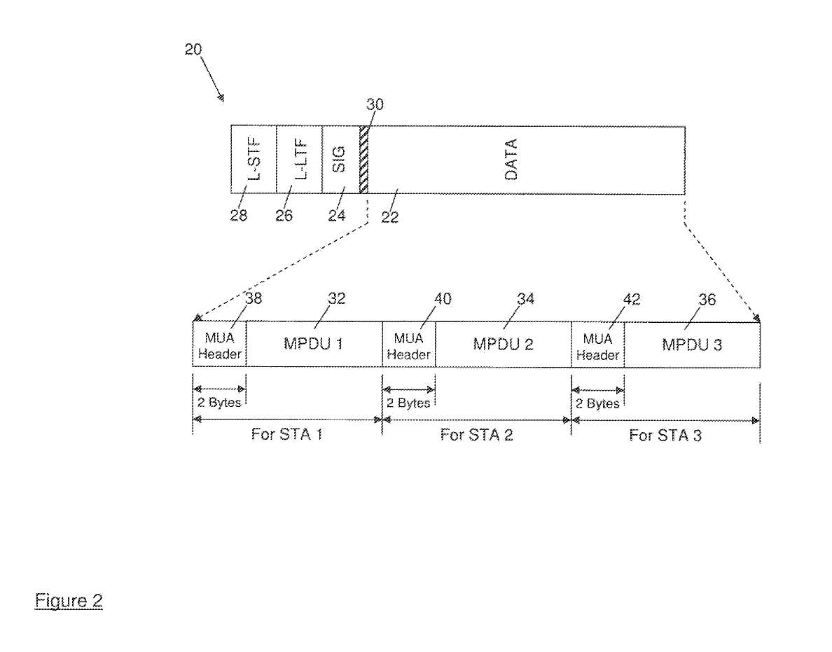

An example of this concept is illustrated schematically in FIG. 2, which shows a physical layer frame 20 having a data portion 22 and header portions 24, 26, 28. The data frame 22 may contain an MUA-MPDU, which itself may contain a plurality of MPDUs intended for different wireless stations.

As part of the header, the frame 20 includes a signalling field 24 (shown as SIG in FIG. 2), which includes an indicator 30 comprising one bit, which indicates whether the data portion 22 of the frame 20 contains an MUA-MPDU. A wireless station receiving the frame 20 can detect the state of the indicator 30 and from it discern whether the received frame 20 is a normal frame containing only a single MPDU in the data portion 22, or whether the data portion 22 contains an MUA-MPDU.

The exemplary frame 20 illustrated in FIG. 2 includes, in its data portion 22, an MUA-MPDU containing first, second and third MPDUs 32, 34, 36, sequentially packed into the data portion 22, each being preceded by a respective MUA header 38, 40, 42 which is two bytes in length.

Each MUA header 38, 40, 42 marks the beginning of the respective MPDU 32, 34, 36, and contains information specifying the length of the MPDU 32, 34, 36 that follows the MUA header 38, 40, 42, such that the end of the MPDU 32, 34, 36 can be determined by a receiving wireless station, allowing the receiving wireless station to identify the different MPDUs 32, 34, 36.

The first MPDU 32 and its associated header 38 are intended for a first wireless station, whilst the second MPDU 34 and its associated header 40 are intended for a second wireless station, and the third MPDU 36 and its associated header 42 are intended for a third wireless station. The receiving station inspects the MAC header within the first MPDU 32 to determine if the first MPDU 32 is intended for the receiving station. If so, the receiving station receives and decodes the first MPDU 32, but may stop receiving the data portion 22 once the whole of the first MPDU 32 has been received, on the basis that the subsequent MPDUs 34, 36 are not intended for the receiving station. Of course, it may be that more than one of the MPDUs 32, 34, 36 is intended for the receiving station, and so the receiving station may continue to receive and decode the data portion 22 and the subsequent MPDUs 34, 36 after the whole of the first MPDU 32 has been received.

If having inspected the MAC header of the first MPDU 32 the receiving wireless station determines that the first MPDU 32 is not intended for the receiving station, the receiving station inspects the MAC header of the second MPDU 34 to determine whether the second MPDU 34 is intended for the receiving station, as described above. Again, if the second MPDU 34 is determined to be intended for the receiving station, the receiving station may stop receiving and decoding the data section 22 once the whole of the second MPDU 34 is received.

The process described above is repeated by the receiving station for all of the MPDUs 32, 34, 36 in the data portion 22 of the frame 20, unless the receiving station is configured to stop receiving the data portion 22 once an MPDU intended for the receiving station is received.

As will be appreciated, for a normal frame containing only a single MPDU, the receiving wireless station receives and decodes the data portion of the frame until the MAC address located at the beginning of the data portion is detected. The MAC address indicates the wireless station for which the frame is intended. If the detected MAC address corresponds to the MAC address of the receiving wireless station, the wireless station continues to receive and decode the remainder of the data portion. If the detected MAC address does not correspond to the MAC address of the receiving wireless station, the station may cease receiving and decoding the data portion, as it is not intended for that station.

In contrast, where a wireless station receives a frame 20 containing an MUA-MPDU, as indicated by the indicator 30, the station may have to receive and decode the whole of the data portion 22 of the frame 20, to determine if the frame 20 contains an MPDU intended for the receiving wireless station.

To address this, in an alternative implementation a MUA Map field comprising a bitmap containing a plurality of bits may be provided in the frame 20, at the start of the data portion 22, prior to the first MPDU 32, to indicate the stations for which there are MPDUs in the MUA-MPDU of the data portion 22. For example, the MUA Map may comprise a bitmap containing two octets, with each bit indicating the inclusion or otherwise of one or more MPDUs for a different group of wireless stations. Using such a two-octet MUA Map field, a particular bit could be set if the Association Identifier (AID) for the recipient of an included MPDU, modulo 16, is equal to the bit number of the bitmap. Under this scheme an MUA-MPDU containing broadcast or multicast frames would have all bits of the MUA Map set since the transmitted data must be received by all stations. Whilst this approach does not guarantee that an MUA-MPDU with a particular station's map bit set will actually include an MPDU for that station, it probabilistically reduces the number of MUA-MPDUs that a particular station will need to decode by the number of bits in the map and without needing to pre-configure explicit groups of STAs.

The indication that the frame 20 contains an MUA-MPDU may be also signalled using a multicast or group identifier, in which case only stations belonging to the multicast group decode the data portion 22 of the frame 20. This type of indication can reduce the unnecessary decoding for stations not targeted in the transmission with extra signalling overhead. However, this method requires signalling exchange to set up the group identifier, and loses the flexibility to dynamically aggregate MPDUs for stations for which downlink traffic is ready for transfer.

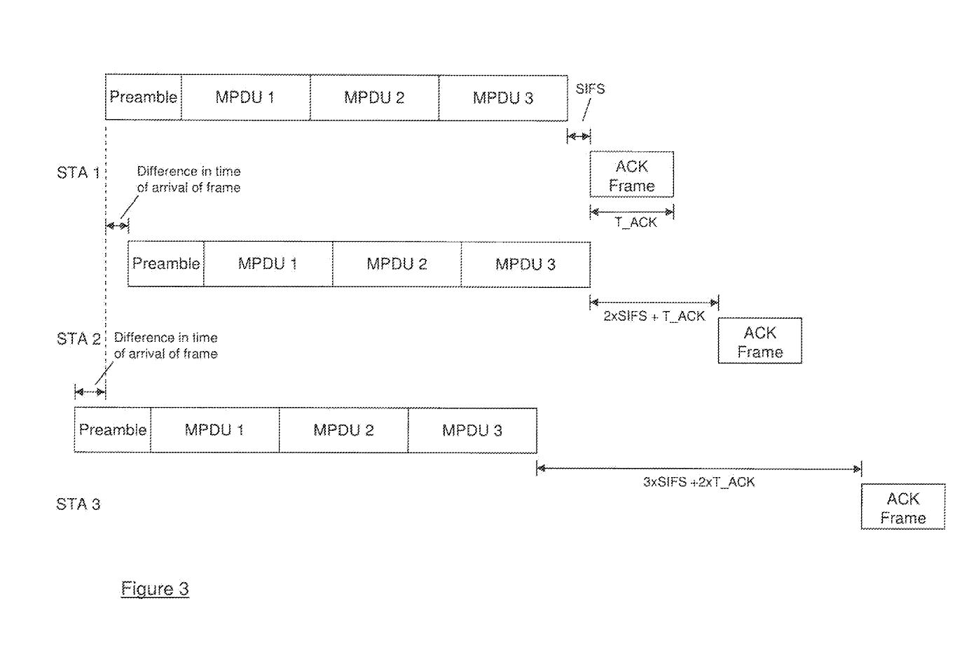

Under the IEEE 802.11 standard, a station receiving a unicast MPDU must transmit an acknowledgement (ACK) message back to the access point that transmitted the MPDU. This requirement applies equally to a situation in which a frame transmitted by an access point contains an MUA-MPDU.

Where the MUA-MPDU contained in the data portion 22 of a frame transmitted by an access point contains only unicast MPDUs, a time period of sufficient length is reserved for the transmission of an immediate ACK for each MPDU contained within the MUA-MPDU for which an acknowledgement is required. This transmission delay is dependent upon the order of the MPDU intended for the station that has received the MPDU, as will be explained below with reference to FIG. 3 of the drawings.

In the example illustrated in FIG. 3, a MUA-MPDU frame contains three MPDUs (MPDU 1, MPDU 2 and MPDU 3), each intended for a different one of three stations, identified as STA 1, STA 2, STA 3 in FIG. 3. The station whose MPDU is the first in the MUA-MPDU has an ACK frame slot that commences one short inter-frame space (SIFS) time period after the end of the MUA-MPDU received by that station. In FIG. 3, this station is STA 1. The ACK frame has a time duration of T_ACK, and is transmitted by the station STA 1 a time 1 SIFS after the end of the MUA-MPDU frame received by STA 1.

The second MPDU, MPDU 2, is intended for station STA 2. In order to ensure that the ACK frame transmitted by STA 1 can be received correctly, STA 2 has an ACK frame slot that commences a total of (2×SIFS)+T_ACK after the end of the MUA-MPDU received by STA 2. This ensures that there is sufficient time for the ACK frame transmitted by STA 1 to be completely received by the access point before STA 2 commences transmitting its ACK frame.

Similarly, the third MPDU, MPDU 3, is intended for station STA 3. In order to ensure that the ACK frames transmitted by STA 1 and STA 2 can be received correctly, STA 3 has an ACK frame slot that commences a total of (3×SIFS)+(2×T_ACK) after the end of the MUA-MPDU received by STA 3. This ensures that there is sufficient time for the ACK frames transmitted by STA 1 and STA 2 to be completely received by the access point before STA 3 commences transmitting its ACK frame.

In more general terms, for a station STA n whose MPDU is the nth MPDU in the MUA-MPDU the ACK frame slot commences at a time (n×SIFS)+((n−1)×T_ACK) after the end of the MUA-MPDU received by that station.

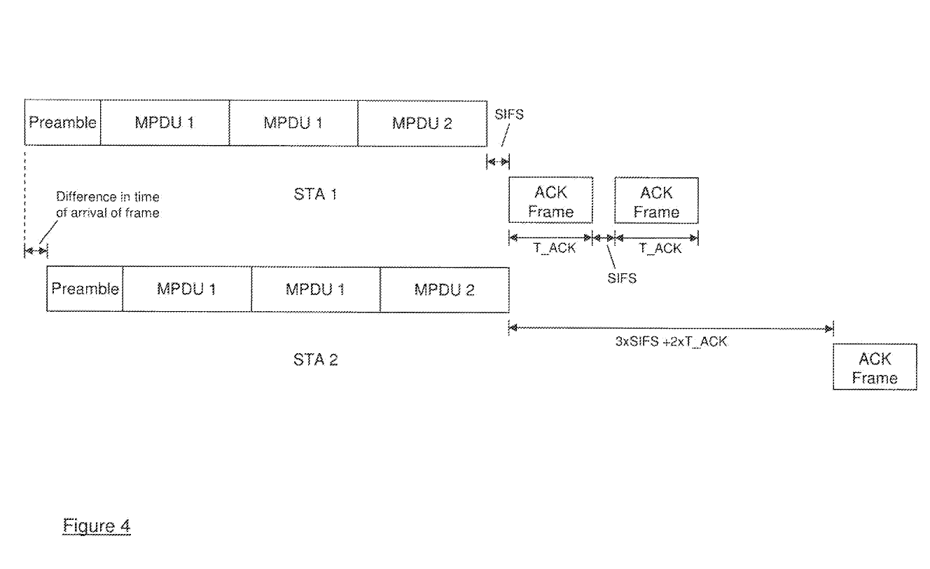

The aggregation scheme described above is intended for a situation in which the total traffic in a wireless network is high, due to a large number of wireless stations in the network, but the traffic duty cycle of each individual station is low. Thus, aggregation of multiple MPDUs intended for the same station is uncommon. However, where this situation arises, the general rule above applies to each MPDU and its corresponding ACK frame, regardless of whether multiple ACK frames are transmitted by the same station in response to receiving multiple MPDUs intended for that station. This is shown schematically in FIG. 4.

When the MUA-MPDU contains only broadcast or multicast MPDUs, no acknowledgement of the MPDUs is required. To enable power saving using microsleep at stations, multicast and broadcast traffic is typically not interleaved with unicast traffic, so that stations which do not expect unicast traffic may enter microsleep mode after receiving multicast or broadcast traffic. Thus, in normal circumstances multicast or broadcast MPDUs will not be interleaved with unicast MPDUs in an MUA-MPDU.

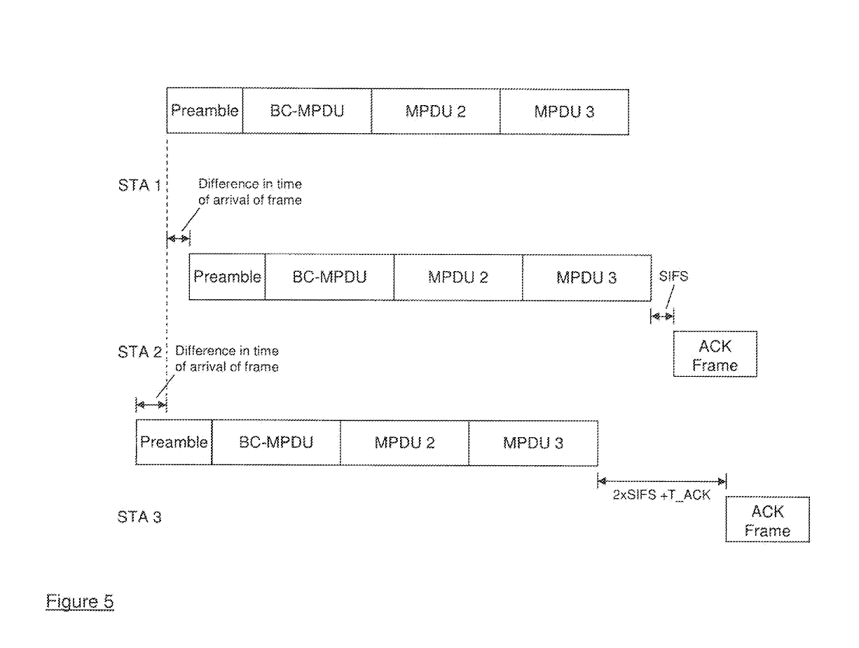

However, there are circumstances in which such interleaving of broadcast or multicast MPDUs with unicast MPDUs will be required. In these circumstances the general rule above applies to each MPDU and its corresponding ACK frame, with an additional stipulation that only unicast MPDUs have time reserved for acknowledgement by a receiving station. This is illustrated schematically in FIG. 5.

In the example illustrated in FIG. 5 the data portion 22 of a frame 20 contains a MUA-MPDU containing a broadcast MPDU (BC-MPDU) and two MPDUs, MPDU 2 and MPDU 3, which are intended for wireless stations 2 and 3 (STA 2, STA 3) respectively.

On receiving the frame 20 the station STA 1 does not transmit an ACK frame, as there are no MPDUs in the MUA-MPDU intended for STA 1, and no ACK frame is required for broadcast MPDUs.

Station STA 2 also receives the transmitted frame 20. As MPDU 2 is intended for STA 2, station STA 2 is the first station for which there is a unicast MPDU. STA 2 does not transmit an ACK frame for the broadcast MPDU, but must issue an ACK frame for MPDU 2. The ACK frame commences at a time one short inter-frame space (SIFS) time period after the end of the MUA-MPDU received by STA 2.

Similarly, station STA 3 receives the transmitted frame 20, and must issue an ACK frame for MPDU3, which is intended for STA 3. The ACK frame for STA 3 commences at a time (2×SIFS)+T_ACK after the end of the MUA-MPDU received by STA 3. This ensures that there is sufficient time for the ACK frame transmitted by STA 2 to be completely received by the access point before STA 3 commences transmitting its ACK frame.

A scheme similar to the MUA-MPDU scheme described above can also be used for transmitting multiple acknowledgements from an access point to multiple stations in a wireless network to improve spectral efficiency.

Normally, each ACK frame transmitted by an access point contains only a receiver address (RA) field, but requires a header that precedes the RA field and a frame check sequence (FCS) field that follows the RA field. It will be appreciated that transmitting multiple ACK frames, each containing only one RA field does not make efficient use of the available spectrum.

To address this problem, the aggregator 12 of the transmitter 10 illustrated in FIG. 1 may be configured to aggregate multiple acknowledgements into a single frame, which will be referred to hereinafter as a Multi User Aggregation ACK MAC Protocol Data Unit, or MUA-ACK MPDU. As for the MUA-MPDU described above, the MUA-ACK MPDU appears to the modulator 14 that operates in the physical layer as a single MPDU, and so a single modulation and coding scheme is applied by the modulator 14 to the MUA-ACK MPDU for transmission to one or more receiving wireless stations. The modulated and coded MUA-ACK MPDU forms part of a signal that is amplified by an amplifier 16 and transmitted via an antenna 18 to the wireless station(s) of the wireless network served by the wireless access point.

By aggregating the acknowledgements into a single MUA-ACK MPDU frame in this way the available frequency spectrum is used more efficiently, as the header and frame check sequence field associated with the acknowledgements occurs only once, in the single MUA-ACK MPDU frame, rather than being present in each, separately transmitted, ACK frame.

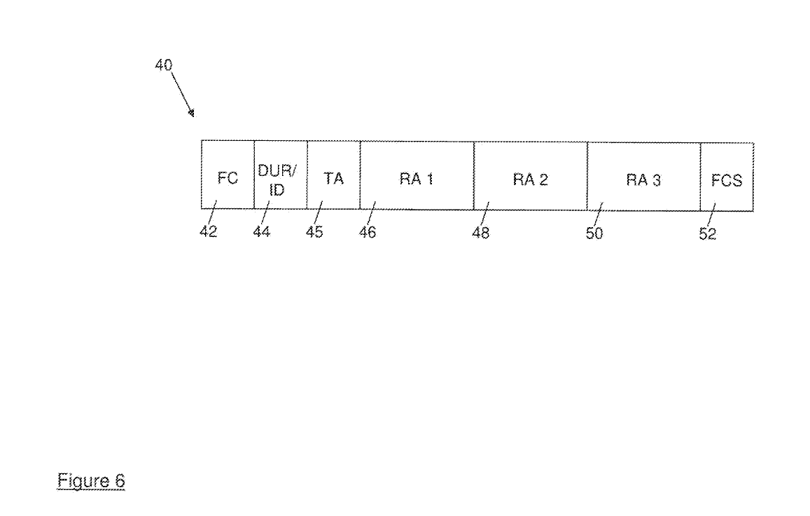

An exemplary MUA-ACK MPDU is shown generally at 40 in FIG. 6. The MUA-ACK MPDU frame 40 comprises a header containing a single frame control (FC) field 42, a duration field 44, and a transmitter address (TA) field 45. This header is followed by three acknowledgements, each containing a respective receiver address (RA) field 46, 48, 50, each of which contains the address of a different station in the wireless network for which an acknowledgement is intended. The RA fields 46, 48, 50 are followed by a single frame check sequence (FCS) field 52.

By aggregating the three acknowledgements into a single MUA-ACK MPDU frame 40 the spectral efficiency of the access point in transmitting ACK frames can be increased, as only a single header and FCS field need be transmitted for a plurality of acknowledgements. As each acknowledgement is very small (e.g. 48 bits), the saving in the overhead in the MUA-ACK MPDU is significant. To ensure that receiving stations are able to detect the acknowledgements contained in the MUA-ACK MPDU, the frame control field 42 indicates whether the MPDU contains multiple acknowledgements intended for different stations.

It will be appreciated that aggregating acknowledgements in this way may increase the delay at a station in receiving an acknowledgement from the access point. Accordingly, the access point must inform the stations in the wireless network how long they should wait to receive an acknowledgement from the access point before assuming that their last transmission failed. In other words, the access point must set an acknowledgement timeout timer of each station.

When setting the new timeout timer value, the access point needs to take into consideration of the balance between acknowledgement delay and transmission efficiency. In other words, the timeout timer value must be long enough to prevent stations from falsely assuming that their last transmission failed, but not so long that transmission by the station is delayed as it waits for an acknowledgement for a previous transmission.

Another implication of this is that an ACK frame cannot be assumed to be transmitted after a time period equal to one short inter-frame space (SIFS) after the end of the frame being acknowledged, so if Deferred ACK is supported then the Duration field of the frame requiring acknowledgement should only cover the frame itself, and not the usual SIFS+T_ACK.

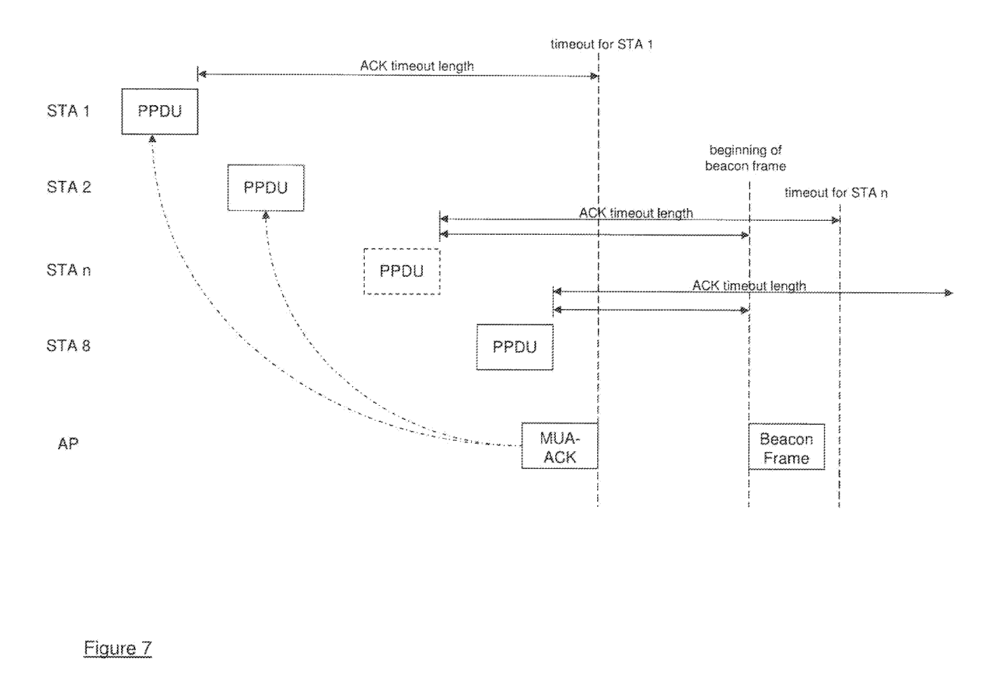

When an access point sets a prolonged timeout value for use by a station when this MUA-ACK MPDU scheme is used, the access point attempts to transmit the MUA-ACK MPDU before the time-out of the first PLCP Protocol Data Unit (PPDU) it correctly receives from a station. As each station expecting to receive a MUA-ACK MPDU will set its own timer with respect to the end of its own transmitted frame, the time-out instance could be well after the transmission of the MUA-ACK frame. To reduce the re-transmission delay, the actual time-out instance is whichever comes earlier between the timer time-out and the arrival of the next beacon frame. This is illustrated schematically in FIG. 7.

In the example illustrated in FIG. 7, a first station STA 1 transmits a PPDU to an access point AP. The AP must issue an MUA-ACK frame to STA 1 within a timeout period of STA 1 to confirm that it has correctly received the PPDU from STA 1. If no MUA-ACK frame is received by STA 1 within the timeout period STA 1 will re-transmit the PPDU.

A second station STA 2 transmits a PPDU to the access point AP. Again, the AP must transmit an MUA-ACK frame to STA 2 within STA 2's timeout period, or STA 2 will assume that the AP did not correctly receive the PPDU.

The AP transmits a MUA-ACK MPDU containing acknowledgements for STA 1 and STA 2. To ensure that STA 1 does not time out and re-transmit its PPDU, the AP transmits the MUA-ACK MPDU before the end of STA 1's timeout period.

A further station, denoted as STA n, transmits a PPDU at a time after the transmission by STA 1 and STA 2 of their PPDUs. STA n has a timeout period with determines the period in which an ACK must be received from the AP to confirm that the PPDU has been correctly received. If STA n does not receive an ACK within this time period it assumes that the PPDU was not successfully received by the AP, and so re-transmits it to the AP. As discussed above, however, because the timeout period of STA n is set with reference to the PPDU transmitted by STA n it is possible that the time out period of STA n could be well after the transmission of the MUA-ACK. Thus, the STA n may wait an unnecessarily long time before timing out. To mitigate against this, STA n is configured to time out either at the end of its timeout period, or on transmission of a beacon frame by the AP. In the example illustrated in FIG. 7, a beacon frame is transmitted before the end of STA n's timeout period, and thus STA n times out at the time of transmission of the beacon frame.

Similarly, a further station, denoted as STA 8 in FIG. 8, transmits a PPDU at a time after the transmission by STA n of its PPDU. As STA 8's timeout period expires after the transmission by the AP of a beacon frame, STA 8 times out at the time of transmission of the beacon frame, rather than at the end of its timeout period, to reduce the re-transmission time of STA 8.

An alternative acknowledgement time-out rule could simply use the time reference set by the beacon frame. Under this alternative scheme, the access point always attempts to send back a MUA-ACK MPDU containing acknowledgements for all PPDUs received from stations during a beacon interval, either prior to or immediately after the next beacon frame.

It will be appreciated that the schemes and techniques described herein improve spectral efficiency in wireless networks, by aggregating MPDU frames and acknowledgements within a single physical layer frame which uses only one header for a plurality of MPDUs or acknowledgements. In this way, the number of headers that must be transmitted is reduced, improving the efficiency with which the available spectrum is used.

1. A method for transmitting information from a wireless access point to one or more wireless stations, the method comprising aggregating a plurality of information units of compatible types into a single data frame, modulating the single data frame and transmitting the modulated data frame containing the plurality of information units to the one or more wireless stations.

2. A method according to claim 1 wherein the method uses a carrier sense multiple access with collision avoidance (CSMA/CA) medium access protocol.

3. A method according to claim 1 wherein the plurality of information units comprises a plurality of IEEE 802.11 MAC protocol data units (MPDUs).

4. A method according to claim 3 wherein the single frame includes an indicator for indicating whether a data portion of the frame contains a plurality of MPDUs intended for different wireless stations.

5. A method according to claim 4 wherein the indicator is provided in a signalling field of the single frame.

6. A method according to claim 3 wherein the plurality of MPDUs are provided in a data portion of the single frame, each of the plurality of MPDUs being associated with a header containing information specifying the length of its associated MPDU.

7. A method according to claim 3 wherein the single data frame further includes a map field, the map field indicating wireless stations for which the MPDUs of the single data frame may be intended.

8. A method according to claim 7 wherein the map field comprises a bitmap containing a plurality of bits, each bit of the bitmap indicating the inclusion of one or more MPDUs for members of a group of wireless stations.

9. A method according to claim 1 wherein the plurality of information units comprises a plurality of acknowledgements for MPDUs received from one or more wireless stations.

10. A method according to claim 9 wherein the single frame further includes a single frame control field, a duration field, a single transmitter address field and a single frame check sequence field.

11. A method according to claim 10 wherein the frame control field contains an indicator to indicate whether the single frame contains a plurality of acknowledgements for one or more wireless stations.

12. A method according to claim 9 wherein the wireless access point is configured to inform the one or more wireless stations of an acknowledge timeout period to determine how long the one or more wireless stations should wait to receive an acknowledgment from the wireless access point.

13. A wireless access point comprising an aggregator configured to aggregate a plurality of information units of compatible types into a single data frame, a modulator configured to modulate the single data frame for transmission to one or more wireless stations.

14. A wireless access point according to claim 13 wherein the wireless access point is configured to use a carrier sense multiple access with collision avoidance (CSMA/CA) medium access protocol.

15. A wireless access point according to claim 13 wherein the plurality of information units comprises a plurality of IEEE 802.11 MAC protocol data units (MPDUs).

16. A wireless access point according to claim 15 wherein the single frame includes an indicator for indicating whether a data portion of the frame contains a plurality of MPDUs intended for different wireless stations.

17. A wireless access point according to claim 16 wherein the indicator is provided in a signalling field of the single frame.

18. A wireless access point according to claim 15 wherein the plurality of MPDUs are provided in a data portion of the single frame, each of the plurality of MPDUs being associated with a header containing information specifying the length of its associated MPDU.

19. A wireless access point according to claim 15 wherein the single data frame further includes a map field, the map field indicating wireless stations for which the MPDUs of the single data frame may be intended.

20. A wireless access point according to claim 19 wherein the map field comprises a bitmap containing a plurality of bits, each bit of the bitmap indicating the inclusion of one or more MPDUs for members of a group of wireless stations.

21. A wireless access point according to claim 13 wherein the plurality of information units comprises a plurality of acknowledgements for MPDUs received from one or more wireless stations.

22. A wireless access point according to claim 21 wherein the single frame further includes a single frame control field, a duration field, a single transmitter address field and a single frame check sequence field.

23. A wireless access point according to claim 22 wherein the frame control field contains an indicator to indicate whether the single frame contains a plurality of acknowledgements.

24. A wireless access point according to claim 21 wherein the wireless access point is configured to inform the one or more wireless stations of an acknowledge timeout period to determine how long the one or more wireless stations should wait to receive an ACK from the wireless access point.

25. A transmission format for transmission of information from a wireless access point to one or more wireless stations, the transmission format comprising a plurality of information units of compatible types aggregated within a single data frame.

26. A transmission format according to claim 25 wherein the plurality of information units comprises a plurality of IEEE 802.11 MAC protocol data units (MPDUs).

27. A transmission format according to claim 25 wherein the plurality of information units comprises a plurality of acknowledgements for MPDUs received from one or more wireless stations.

28. A method of receiving at a wireless station a data frame transmitted by a wireless access point, the data frame containing a plurality of IEEE 802.11 MAC protocol data units (MPDUs), the method comprising identifying an nth one of the plurality of MPDUs that is intended for the receiving wireless station and transmitting an acknowledgement (ACK) to the wireless access point in a time slot commencing (n×SIFS)+((n−1)×T_ACK) after the end of the data frame received by the wireless station, where SIFS is the duration of a short inter-frame space and T_ACK is the duration of an ACK transmitted by the wireless station to the wireless access point.

29. A wireless station for receiving from a wireless access point a data frame containing a plurality of IEEE 802.11 MAC protocol data units (MPDUs), the wireless station being configured to identify an nth one of the plurality of MPDUs that is intended for the wireless station and to transmit an acknowledgement (ACK) to the wireless access point in a time slot commencing (n×SIFS)+((n−1)×T_ACK) after the end of the data frame received by the wireless station, where SIFS is the duration of a short inter-frame space and T_ACK is the duration of an ACK transmitted by the wireless station to the wireless access point.
